(19) United States
(12) Patent Application Publication
(10) Pub. No.: US 2010/0257986 A1
(43) Pub. Date: Oct. 14, 2010

(54) APPARATUS AND METHOD FOR ROBOTIC DEBURR AND MATERIAL REMOVAL

(76) Inventors: James Borg, Macomb, MI (US); Don Faulkner, Leonard, MI (US); Mark Bole, Imlay City, MI (US); Craig Fester, Shelby, MI (US); Charles Spoutz, Grosse Pointe Woods, MI (US); Donald Keinath, Rochester, MI (US); Virgil Wilson, Sterling Heights, MI (US)

Correspondence Address: FRASER CLEMENS MARTIN & MILLER LLC, 28366 KENSINGTON LANE, PERRYSBURG, OH, 43551, US

(21) Appl. No.: 12/757,164

(22) Filed: Apr. 9, 2010

Related U.S. Application Data
(60) Provisional application No. 61/167,973, filed on Apr. 9, 2009.

(51) Int. Cl. B26D 1/14

(52) U.S. Cl. 83/13; 83/508.1

(57) ABSTRACT

An apparatus for cutting, deburring, deflashing and removing material from a workpiece includes a housing mounted to a robot, a collet coupled to the housing, a shaft disposed in the housing and coupled to the collet such that a rotation of the shaft results in a rotation of the collet, wherein the shaft is selectively toggled between a locked position and an unlocked position, and a blade holder disposed in the collet and including a blade coupled thereto, wherein a freedom of movement of the blade is determined based on a position of the shaft.

### CROSS-REFERENCE TO RELATED APPLICATION

This application claims the benefit of U.S. provisional patent application Ser. No. 61/167,973 filed Apr. 9, 2009.

### FIELD OF THE INVENTION

The present invention relates generally to a deburring/material removal end of arm tool (EOAT) which has the flexibility to lock a tool into a known position and to unlock the tool to allow 180 degrees of controlled compliance motion.

### BACKGROUND OF THE INVENTION

Current methods for trimming flash from a blow-molded plastic part include the steps of positioning the cutting tip relative to the part by engaging the part with the contoured section of the cutting tool and cutting flash from the part by rotating the cutting tip while moving the cutting tip along the periphery of the part.

Typically, a portion of the cutting tool is guided along the part and conforms to the shape of the part, thereby providing a broad surface to support the tool.

Certain robotic tools in the art use a compliance device to monitor an amount of force being applied to a blade of the tool and do not allow the blade to rotate to match a contour of the part.

Shortcomings of prior art:

conventional tools cannot deburr tight round surfaces and complex contours with a fixed blade without cutting into the parent material of the part; and

a sensitivity of a conventional compliance device of the current tooling is not sensitive enough to deburr a hot part with accuracy.

It would be desirable to have an apparatus and a method for robotic deburr and material removal, wherein the apparatus and the method overcome the shortcomings of the prior art discussed above.

### SUMMARY OF THE INVENTION

Concordant and consistent with the present invention, an apparatus and a method for robotic deburr and material removal, wherein the apparatus and the method overcome the shortcomings of the prior art discussed herein above, have surprisingly been discovered.

In one embodiment, an apparatus for cutting, deburring, deflashing and removing material from a workpiece comprises: a housing mounted to a robot; a collet coupled to the housing; a shaft disposed in the housing and coupled to the collet such that a rotation of the shaft results in a rotation of the collet, wherein the shaft is selectively toggled between a locked position and an unlocked position; and a blade holder disposed in the collet and including a blade coupled thereto, wherein a freedom of movement of the blade is determined based on a position of the shaft.

In another embodiment, a system for cutting, deburring, deflashing and removing material from a workpiece comprises: a robot having a moveable arm; a controller in signal communication with the robot to control a movement of the arm; a housing mounted to the arm of the robot; a collet coupled to the housing; a blade holder disposed in the collet and including a blade coupled thereto; and a force sensor disposed between the housing and the arm to detect a force exerted therebetween, wherein the force sensor generates a feedback signal representative of a measurement of the force sensor, and wherein the controller receives the feedback signal and controls the movement of the arm in response to the feedback signal.

The invention also provides methods for cutting, deburring, deflashing and removing material from a workpiece.

One method comprises the steps of: providing a robot having a moveable arm; providing a tool mounted to the arm, wherein the tool includes a housing; a collet coupled to the housing, a blade holder disposed in the collet and including a blade coupled thereto, and a force sensor disposed between the housing and the arm to detect a force exerted therebetween; generating a feedback representative of a measurement of the force sensor; and controlling a movement of the arm in response to the feedback signal.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a workcell according to an embodiment of the present invention;

FIG. 2 is a perspective view of a robotic deburr and material removal apparatus in accordance with the present invention;

FIG. 3 is an exploded view of the apparatus in FIG. 2;

FIG. 4 is a perspective view of a fixture for use with the apparatus shown in FIG. 2; and

FIG. 5 is another perspective view of the fixture shown in FIG. 4.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

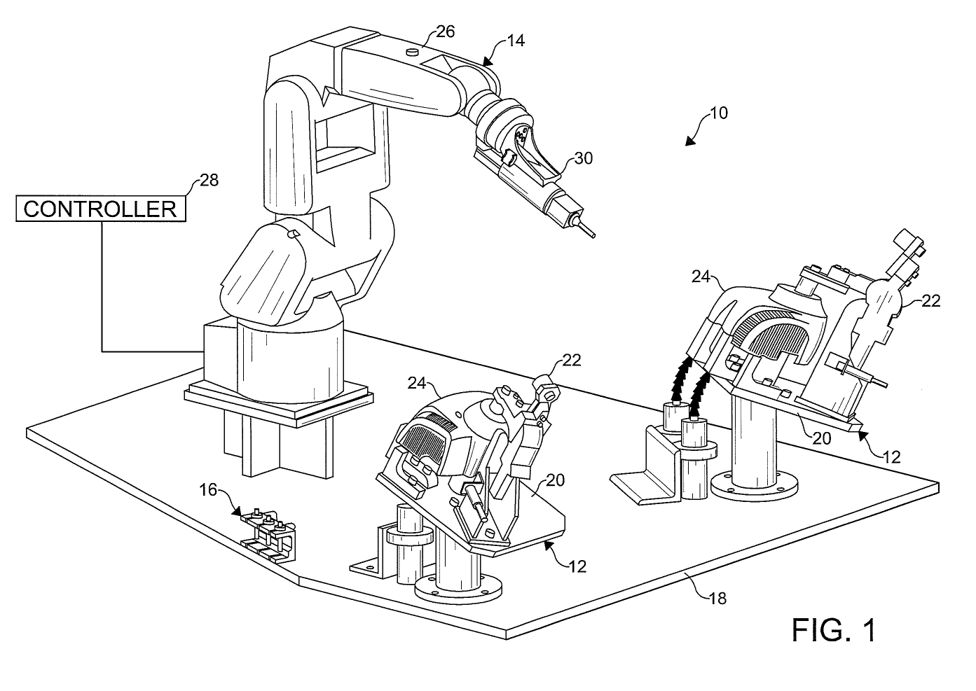

FIG. 1 illustrates a robotic workcell 10 according to an embodiment of the present invention. As shown, the workcell 10 includes a plurality of workpiece fixtures 12, a robot 14, and a blade holder fixture 16. As a non-limiting example, each of the workpiece fixtures 12, the robot 14, and the blade holder fixture 16 is mounted to a fixture base 18 or work surface. However, it is understood that any configuration and orientation of components can be used.

The workpiece fixtures 12 each include a base component 20 and a moveable clamp 22 which cooperate to secure a product 24 to the workpiece fixture 12. In certain embodiments, the base component 20 is selectively moveable relative to the fixture base 18. It is understood that any clamp or securing means can be used to secure the workpiece 24 in a fixed and pre-determined position and orientation.

The robot 14 includes an arm 26 moveable relative to the fixture base 18. As a non-limiting example, a controller 28 is in signal communication with the robot 14 to control the movements thereof. A deburr and material removal end of arm tooling 30 (hereinafter referred to as EOAT) is mounted to the arm 26 and arranged to allow the robot 14 to manipulate the EOAT 30 to various positions and orientations relative to the workpiece fixtures 12 and the blade holder fixture 16.

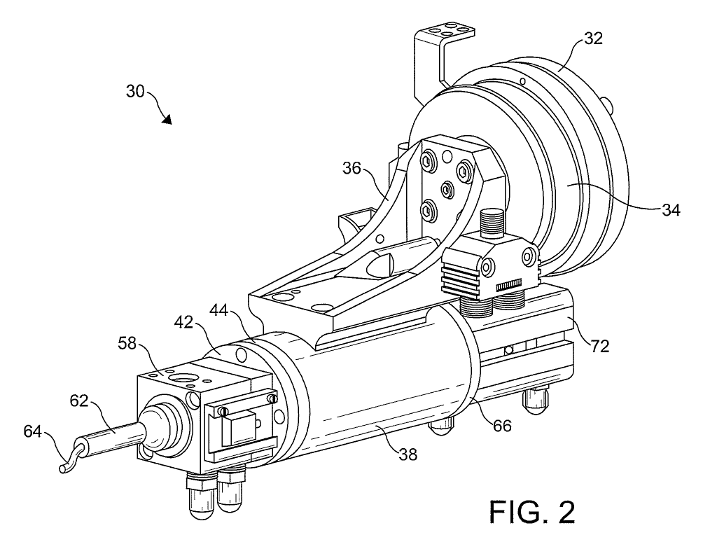

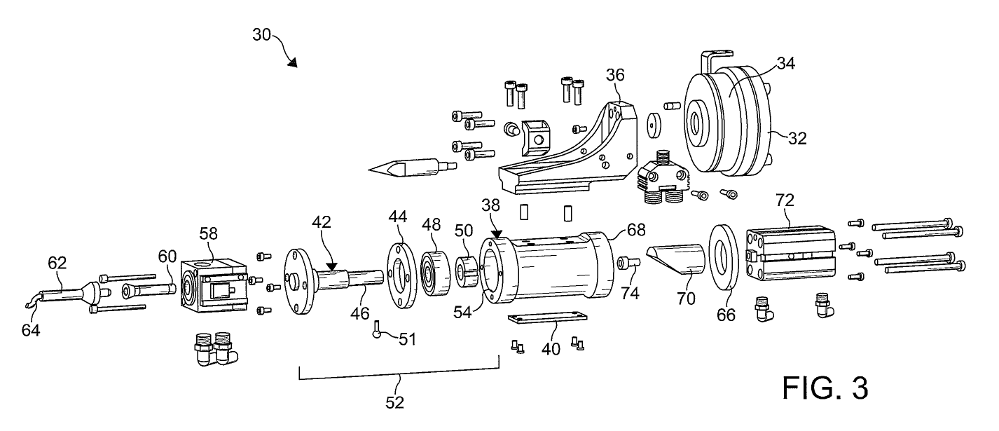

As more clearly shown in FIGS. 2-3, the EOAT 30 includes a force sensor adaptor plate 32 mounted to a robot face plate (not shown) on the arm 26, wherein a force sensor 34 is mounted to the adaptor plate 32. As a non-limiting example, the force sensor 34 is in signal communication with the controller 28 to generate a feedback signal representing measurements of the force sensor 34. As a further non-limiting example, the force sensor 34 is a FS-10iA force sensor manufactured by FANUC Ltd. (Japan), and capable of providing feedback to the controller 28 in any number of predetermined dimensions (e.g. “X” and “Y” directions). It is understood that the controller 28 can adjust a position and orientation of the EOAT 30 in response to analysis of the feedback signal.

A main mounting bracket 36 of the EOAT 30 mounts to the force sensor 34, wherein the main mounting bracket 36 is the primary infrastructure of the EOAT 30 and a plurality of fixed mounted components are assembled thereto.

Specifically, a housing 38 is mounted to the main mounting bracket 36. As a non-limiting example, the housing 38 includes a removable bottom cover 40. A shaft 42 is inserted through a front cap 44 such that an elongate portion 46 of the shaft 42 extends through an aperture formed in the front cap 44. A slide bearing 48 is disposed on the elongate portion 46 of the shaft 42 adjacent the front cap 44. A slide bearing nut 50 threadably engages the elongate portion 46 of the shaft 42 to secure the slide bearing 48 to the shaft 42. Once the slide bearing nut 50 is secured, a tooling ball 51 is coupled to the shaft 42 in a pre-determined position and orientation. The shaft 42 along with the components coupled thereto (i.e. a shaft assembly 52) is disposed through a front side 54 of housing 38.

A compact collet closer 58 is mounted to the shaft 42 adjacent the front side 54 of the housing 38, wherein the collet closer 58 receives a collet 60 therein. As a non-limiting example the collet 60 is a 1C collet manufactured by Hardinge, Inc. (Elmira, N.Y.). A blade holder 62 having a blade 64 coupled thereto is inserted into the collet 60. It is understood that the blade holder 62 can be retained and released by the collet 60 by actuating the collet closer 58 to toggle the collet 60 between an opened and a closed position. It is understood that the collet 60 can receive other tools and devices such as a teaching pointer for configuring the EOAT 30.

A rear cap 66 is coupled to a rear side 68 of the housing 38. A locating sleeve 70 having a predetermined shape and contour is coupled to the rear cap 66. As a non-limiting example, the locating sleeve 70 is disposed in the housing 38 in a pre-determined position and orientation to selectively cooperate with the tooling ball 51. A compact cylinder 72 is coupled to the rear cap 66 on a side of the rear cap 66 opposite the locating sleeve 70. As a non-limiting example, the compact cylinder 72 is an air cylinder manufactured by Festo Corporation (Hauppauge, N.Y.). A member 74 is coupled to the cylinder 72 and is caused to move when the cylinder 72 is actuated, as can be appreciated by one skilled in the art.

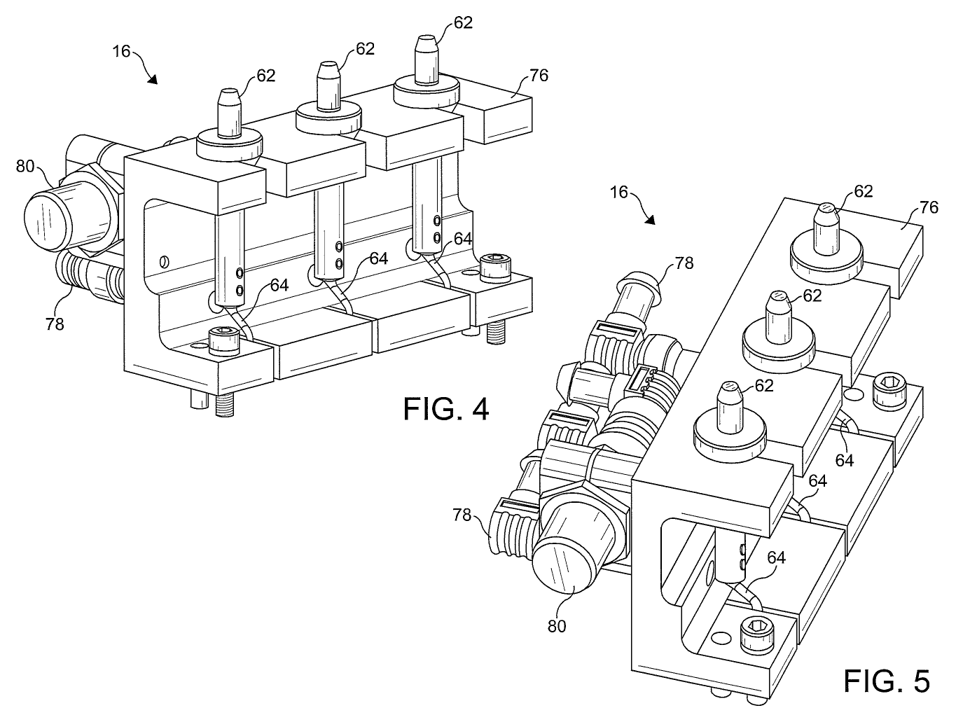

As more clearly shown in FIGS. 4-5, the blade holder fixture 16 includes a main body 76 configured to releasably store a plurality of the blade holders 62, wherein each of the blade holders 62 has one of the blades 64 coupled thereto. A plurality of holder sensors 78 are disposed adjacent the main body 76 to detect a number of the blade holders 62 stored on the blade holder fixture 16. A blade sensor 80 is also disposed adjacent the main body 76 and configured to detect the presence of the blade 64 on one of the blade holders 62 passing through a sensing zone of the blade sensor 80. As a non-limiting example, when a change blade routine is called, the robot 14 moves to a known position where a used one of the blade holders 62 (currently mounted on the EOAT 30) is released by actuating the collet closer 58. The robot 14 then moves to the blade holder fixture 16, picks a new one of the blade holders 62 from the fixture 16, clears the fixture 16, and moves past the blade sensor 80 to ensure the blade 64 is present.

The EOAT 30 is configured to execute a wide variety of robotic cutting, deburr, deflash and material removal operations. In operation, the blade 64 is inserted into the blade holder 62 and the blade holder 62 is inserted into the collet 60. The collet 60 is closed by actuating the collet closer 58 to secure the blade holder 62 in the collet 60. Once the collet 60 is closed, the blade holder 62 and the blade 64 are in a fixed position relative to the collet 60 and collet closer 58. However, the collet closer 58 is mounted to the shaft 42 and is caused to rotate along with the shaft 42.

In certain embodiments, the shaft 42 is placed into a locked position, wherein the shaft 42 is in a substantially fixed rotational position. As a non-limiting example, the cylinder 72 is actuated and the member 74 forces the shaft 42 to move into the locked position, whereby the tooling ball 51 is in a fixed position relative to the housing 38 and the shaft 42 is not able to rotate (also known as the “blade lock feature”). As such, the blade holder 62 and the blade 64 can be locked in a known (fixed) position at a path start for straight line applications. The blade lock feature is preferred for applications where: a robotic deburr & material removal path is started at the same (known) position every time; a robotic deburr & material removal path is not complicated or consistently the same (e.g. straight line); and a material removed is considerably harder than plastic, and gouging of the part is not possible (at start thru finish). However, the blade lock feature can be used with other applications.

In certain embodiments, the shaft 42 is placed into an unlocked position, wherein a rotation of the shaft 42 is allowed. As a non-limiting example, the cylinder 72 is actuated and the member 74 forces the shaft 42 to move into the unlocked position, whereby the tooling ball 51 is free to move and the shaft 42 is able to rotate (also known as the “blade unlock feature”). In certain embodiments, the blade unlock feature allows the blade 64 to rotate about 180 degrees of total rotation (+90 or −90 degrees from tool center), increasing a flexibility of the blade 64 when attempting multiple path direction changes and tight radial articulation. It is understood that a rotation of the blade 64 can be limited by any structure in the housing 38 such as the locating sleeve 70, for example. The blade unlock feature is preferred for applications such as deburring an inner diameter of a hole. However, other applications can be used.

In certain embodiments, the blade 64 is in a locked (known) position and selectively unlocked as the EOAT 30 moves thru a path, thereby allowing the blade 64 to articulate thru tight radial moves. It is understood that the blade 64 can be locked again as it nears the end of its path so that at a next cycle start the blade 64 is in the locked (known) position. A combination of the blade lock feature and the blade unlock feature can be used where a material removed may have variable rigidity and a path requires multiple direction changes which may damage the part due to the blade digging to deep or gouging. It is understood that the blade 64 can be locked at anytime to achieve accurate straight cuts, but released on-demand to allow for contoured cuts.

After the workpiece 24 has been deburred and material has been removed the robot 14 moves the EOAT 30 to clear the workpiece fixture 12, the clamps 22 open and the workpiece 24 is removed and sent to the next operation.

As discussed above, the EOAT 30 includes the force sensor 34 that detects forces and moments acting on the EOAT 30 (e.g. at the blade 64 or elsewhere). The force sensor 34 enables the robot 14 to complete a variety of material removal operations, including cutting, deburring & deflashing. Standard schedule-based algorithms are provided to support a variety of common material removal processes, allowing each path to be optimized for superior quality. Once a force schedule is set, a force control instruction is added to the robot program (e.g. executed by the control 28) to perform the material removal operation.

As a non-limiting example force control features include:

a) Contouring—apply a constant force on a surface of the workpiece 24 while the EOAT 30 moves along a path during cutting, deburring and deflashing operations. It is understood that contouring force schedules include approach velocity, contact force, push force and push direction information. It is further understood that taught robot positions are dynamically shifted during material removal operations to provide programmed force along the specified direction;

b) Built-in Diagnostics—the force sensor 34 is configured to fault if the defined programmed forces are exceeded, reducing the possibility of damage to the workpiece 24 and ensuring superior quality;

c) Simple to use—simple data setup menus for force control and standard teach pendant programming for application development make the Intelligent Robots simple to operate;

d) Offline Programming—offline programming of the force control function allow for a total intelligent solution;

e) Intelligent Force Control—different force directions can be programmed for the same tool by using and defining the direction in different force schedules;

f) Force data viewer on iPendant™—Allows continuous display of actual force variations during the force control operation; and

g) Color-graphic iPendant™ with browser-based interface—a multiple-window, color-graphic interface allows simultaneous display of a robot program, force setup, and real-time force/moment (Fx, Fy, Fz, Mx, My, Mz) information during production operation.

The EOAT 30 according to the present invention provides on demand cutting blade rotation of 180 degrees (+90/−90 about tool center), wherein a rotation of the blade 64 can be locked or unlocked in a known position at any point in time. The EOAT 30 includes the capability of automatic blade changes. The EOAT 30 also includes the force sensor which provides an intelligent robot that can “feel” the workpiece.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An apparatus for cutting, deburring, deflashing and removing material from a workpiece comprising:
a housing mounted to a robot;
a collet coupled to the housing;
a shaft disposed in the housing and coupled to the collet such that a rotation of the shaft results in a rotation of the collet, wherein the shaft is selectively toggled between a locked position and an unlocked position; and
a blade holder disposed in the collet and including a blade coupled thereto, wherein a freedom of movement of the blade is determined based on a position of the shaft.

2. The apparatus according to claim 1, wherein the shaft is substantially fixed relative to the housing while in the locked position, whereby the freedom of movement of the blade is substantially fixed.

3. The apparatus according to claim 1, wherein the shaft is allowed to rotate while in the unlocked state.

4. The apparatus according to claim 1, further comprising a tooling ball coupled to the shaft, wherein the tooling ball engages a fixed structure disposed adjacent the housing to limit a rotation of the shaft.

5. The apparatus according to claim 1, further comprising a compact cylinder coupled to the shaft to selectively cause the shaft to toggle between the locked position and the unlocked position.

6. The apparatus according to claim 1, further comprising a force sensor coupled to the housing to detect a force exerted thereon, wherein the force sensor generates a feedback signal representative of a measurement of the force sensor.

7. The apparatus according to claim 1, further comprising a controller in signal communication with the robot to control a movement thereof, wherein the controller receives the feedback signal and controls the movement of the robot in response to the feedback signal.

8. The apparatus according to claim 1, further comprising a collet closer coupled to the shaft to receive the collet, wherein the collet closer is actuated to toggle the collet between a closed position and an open position.

9. A system for cutting, deburring, deflashing and removing material from a workpiece comprising:
a robot having a moveable arm;
a controller in signal communication with the robot to control a movement of the arm;
a housing mounted to the arm of the robot;
a collet coupled to the housing;
a blade holder disposed in the collet and including a blade coupled thereto; and
a force sensor disposed between the housing and the arm to detect a force exerted therebetween, wherein the force sensor generates a feedback signal representative of a measurement of the force sensor, and wherein the controller receives the feedback signal and controls the movement of the arm in response to the feedback signal.

10. The system according to claim 9, further comprising a shaft disposed in the housing and coupled to the collet such that a rotation of the shaft results in a rotation of the collet, wherein the shaft is selectively toggled between a locked position and an unlocked position, and wherein a freedom of movement of the blade relative to the housing is responsive to the position of the shaft.

11. The system according to claim 10, wherein the shaft is substantially fixed relative to the housing while in the locked position, whereby the freedom of movement of the blade is substantially fixed.

12. The system according to claim 10, wherein the shaft is allowed to rotate while in the unlocked state.

13. The system according to claim 10, further comprising a tooling ball coupled to the shaft, wherein the tooling ball engages a fixed structure disposed adjacent the housing to limit a rotation of the shaft.

14. The system according to claim 10, further comprising a compact cylinder coupled to the shaft to selectively cause the shaft to toggle between the locked position and the unlocked position.

15. The system according to claim 10, further comprising a collet closer coupled to the shaft to receive the collet, wherein the collet closer is actuated to toggle the collet between a closed position and an open position.

16. The system according to claim 9, further comprising a blade holder fixture having a main body configured to releasably store a plurality of the blade holders, wherein the arm of the robot is moveable to and from the blade holder fixture to retrieve any of the blade holders stored thereon.

17. The system according to claim 16, wherein the blade holder fixture includes at least one of a blade holder sensor to detect a number of the blade holders stored on the blade holder fixture and a blade sensor to detect a presence of a blade on one of the blade holders passing through a sensing zone of the blade sensor.

18. A method for cutting, deburring, deflashing and removing material from a workpiece comprising the steps of:
providing a robot having a moveable arm;
providing a tool mounted to the arm, wherein the tool includes a housing, a collet coupled to the housing, a blade holder disposed in the collet and including a blade coupled thereto, and a force sensor disposed between the housing and the arm to detect a force exerted therebetween;
generating a feedback representative of a measurement of the force sensor; and
controlling a movement of the arm in response to the feedback signal.

19. The method according to claim 18, wherein the tool includes a shaft disposed in the housing and coupled to the collet such that a rotation of the shaft results in a rotation of the collet, wherein the shaft is selectively toggled between a locked position and an unlocked position, and wherein a freedom of movement of the blade relative to the housing is responsive to the position of the shaft.

20. The method according to claim 18, further comprising the step of providing a blade holder fixture having a main body configured to releasably store a plurality of the blade holders, wherein the arm of the robot is moveable to and from the blade holder fixture to retrieve one of the blade holders stored thereon.
